(19) United States
(12) Patent Application Publication
(10) Pub. No.: US 2014/0367457 A1
(43) Pub. Date: Dec. 18, 2014

(54) FOLDER

(71) Applicant: Ideastream Consumer Products, LLC, Cleveland, OH (US)

(72) Inventor: Eric Fitzgerald Klosky, Chagrin Falls, OH (US)

(21) Appl. No.: 14/473,261

(22) Filed: Aug. 29, 2014

Related U.S. Application Data
(63) Continuation of application No. 29/466,471, filed on Sep. 9, 2013, now Pat. No. D712468.
Application No. 29/466,471 is a division of application No. 29/388,234, filed on Mar. 25, 2011, now Pat. No. D691195.

(51) Int. Cl. B42F 21/02

(52) U.S. Cl. CPC B42F 21/02
USPC 229/67.1

(57) ABSTRACT

The folders are generally arranged as non-square rectangles with a tab and some rounded corners and with their longitudinal axes oriented vertically. They are preferably closed along some or all of the bottom edge and along some or all of one of the side edges. For example, the folders can be formed by a folded edge at one side edge and by a folded glue flap that is glued with suitable adhesive to the inside or the outside to form the bottom edge. Alternatively, they can be closed along some or all of the bottom edge, closed along some or all of one of the side edges, and closed along some or all of the other side edge. For example, the folders can be formed by a folded edge at one side edge, by a folded glue flap that is glued with suitable adhesive to the inside or the outside to form the bottom edge, and by a folded glue flap that is glued with suitable adhesive to the inside or the outside to form the other side edge. As another For example, the folders can be formed by a folded edge the bottom edge, by a folded glue flap that is glued with suitable adhesive to the inside or the outside to form the one side edge, and by a folded glue flap that is glued with suitable adhesive to the inside or the outside to form the other side edge.

### CROSS-REFERENCE TO RELATED APPLICATIONS

This application is a continuation of U.S. patent application Ser. No. 29/466,471, filed Sep. 9, 2013, and entitled FOLDER (Attorney Docket 31622/04112) which is a divisional of U.S. patent application Ser. No. 29/388,234, filed Mar. 25, 2011, and entitled FOLDER (Attorney Docket 31622/04078) the entire disclosures of which are hereby incorporated herein by reference in their entirety.

### DESCRIPTION OF THE FIGURES

FIG. 1 is a front/right/top perspective view of a first embodiment of the folder (left tab; no gusset; attached left and bottom);

FIG. 2 is a front elevational view thereof;

FIG. 3 is a rear elevational view thereof;

FIG. 4 is a top plan view thereof;

FIG. 5 is a bottom plan view thereof;

FIG. 6 is a left side elevational view thereof; and

FIG. 7 is a right side elevational view thereof.

FIG. 8 is an optional front/left/top perspective view thereof, with the front surface optionally curled from upper right to lower left.

A second embodiment of the folder (right tab; no gusset; attached right and bottom) is attached at the bottom and right edges and has front and rear elevational views that are mirror images (vertical mirror line) of FIGS. 2 and 3, respectively; top and bottom plan views are mirror images (vertical mirror line) of FIGS. 4 and 5, respectively; and left and right side elevational views are mirror images (horizontal mirror line) of FIGS. 7 and 6, respectively.

FIG. 9 is a front/right/top perspective view of a third embodiment of the folder (center tab; no gusset; attached left and bottom);

FIG. 10 is a front elevational view thereof;

FIG. 11 is a rear elevational view thereof;

FIG. 12 is a top plan view thereof;

FIG. 13 is a bottom plan view thereof;

FIG. 14 is a left side elevational view thereof; and

FIG. 15 is a right side elevational view thereof.

FIG. 16 is an optional front/left/top perspective view thereof, with the front surface optionally curled from upper right to lower left.

A fourth embodiment of the folder (center tab; no gusset; attached right and bottom) is attached at the bottom and right edges and has front and rear elevational views that are mirror images (vertical mirror line) of FIGS. 10 and 11, respectively; top and bottom plan views are mirror images (vertical mirror line) of FIGS. 12 and 13, respectively; and left and right side elevational views are mirror images (horizontal mirror line) of FIGS. 15 and 14, respectively.

FIG. 17 is a front/right/top perspective view of a fifth embodiment of the folder (right tab; no gusset; attached left and bottom);

FIG. 18 is a front elevational view thereof;

FIG. 19 is a rear elevational view thereof;

FIG. 20 is a top plan view thereof;

FIG. 21 is a bottom plan view thereof;

FIG. 22 is a left side elevational view thereof; and

FIG. 23 is a right side elevational view thereof.

FIG. 24 is an optional front/left/top perspective view thereof, with the front surface optionally curled from upper right to lower left.

A sixth embodiment of the folder (left tab; no gusset; attached right and bottom) is attached at the bottom and right edges and has front and rear elevational views that are mirror images (vertical mirror line) of FIGS. 18 and 19, respectively; top and bottom plan views are mirror images (vertical mirror line) of FIGS. 20 and 21, respectively; and left and right side elevational views are mirror images (horizontal mirror line) of FIGS. 23 and 22, respectively.

FIG. 25 is a front/right/top perspective view of a seventh embodiment of the folder (left tab; gusset; attached left and bottom);

FIG. 26 is a front elevational view thereof;

FIG. 27 is a rear elevational view thereof;

FIG. 28 is a top plan view thereof;

FIG. 29 is a bottom plan view thereof;

FIG. 30 is a left side elevational view thereof; and

FIG. 31 is a right side elevational view thereof.

FIG. 32 is an optional front/left/top perspective view thereof, with the front surface optionally curled from upper right to lower left.

FIG. 33 is an optional front elevational view thereof, with the gusset optionally extended out, which configuration might be used for packaging and shipping.

An eighth embodiment of the folder (right tab; gusset; attached right and bottom) is attached at the bottom and right edges and has front and rear elevational views that are mirror images (vertical mirror line) of FIGS. 26 and 27, respectively; top and bottom plan views are mirror images (vertical mirror line) of FIGS. 28 and 29, respectively; and left and right side elevational views are mirror images (horizontal mirror line) of FIGS. 31 and 30, respectively.

FIG. 34 is a front/right/top perspective view of a ninth embodiment of the folder (center tab; gusset; attached left and bottom);

FIG. 35 is a front elevational view thereof;

FIG. 36 is a rear elevational view thereof;

FIG. 37 is a top plan view thereof;

FIG. 38 is a bottom plan view thereof;

FIG. 39 is a left side elevational view thereof; and

FIG. 40 is a right side elevational view thereof.

FIG. 41 is an optional front/left/top perspective view thereof, with the front surface optionally curled from upper right to lower left.

FIG. 42 is an optional front elevational view thereof, with the gusset optionally extended out, which configuration might be used for packaging and shipping.

A tenth embodiment of the folder (center tab; gusset; attached right and bottom) is attached at the bottom and right edges and has front and rear elevational views that are mirror images (vertical mirror line) of FIGS. 35 and 36, respectively; top and bottom plan views are mirror images (vertical mirror line) of FIGS. 37 and 38, respectively; and left and right side elevational views are mirror images (horizontal mirror line) of FIGS. 40 and 39, respectively.

FIG. 43 is a front/right/top perspective view of a eleventh embodiment of the folder (right tab; gusset; attached left and bottom);

FIG. 44 is a front elevational view thereof;

FIG. 45 is a rear elevational view thereof;

FIG. 46 is a top plan view thereof;

FIG. 47 is a bottom plan view thereof;

FIG. 48 is a left side elevational view thereof; and

FIG. 49 is a right side elevational view thereof.

FIG. 50 is an optional front/left/top perspective view thereof, with the front surface optionally curled from upper right to lower left.

FIG. 51 is an optional front elevational view thereof, with the gusset optionally extended out, which configuration might be used for packaging and shipping.

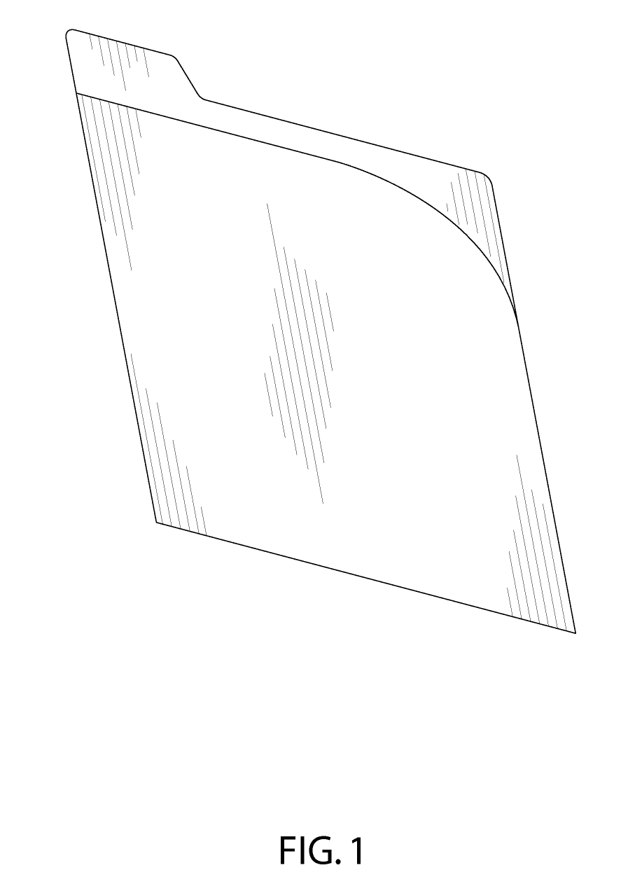

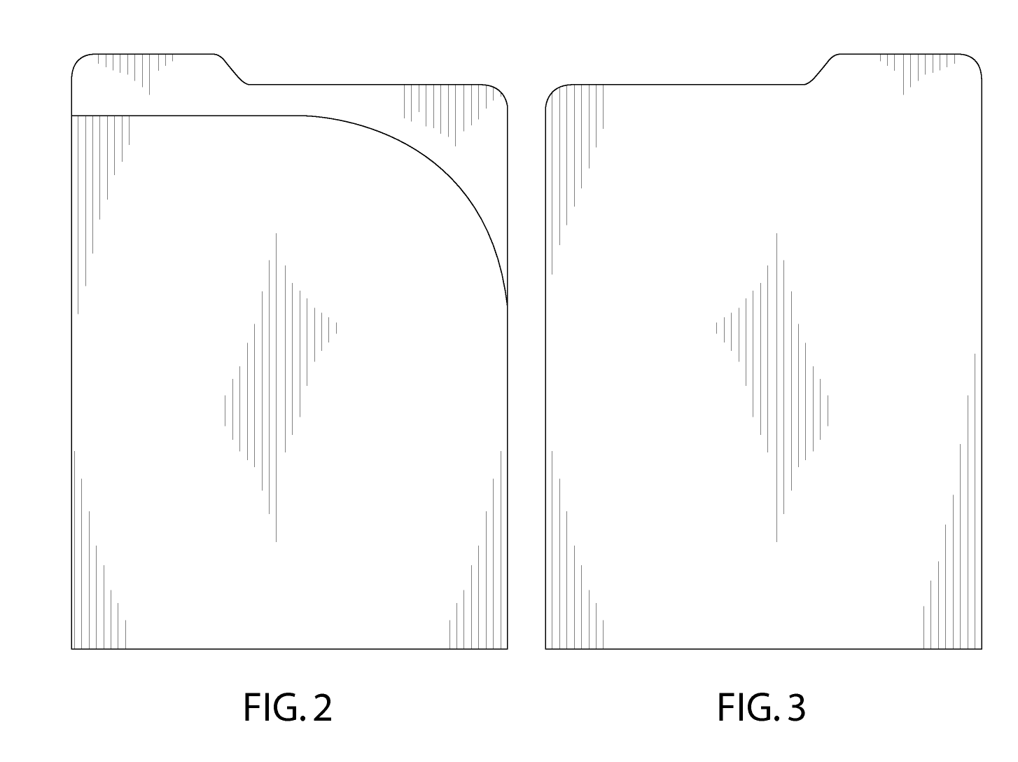

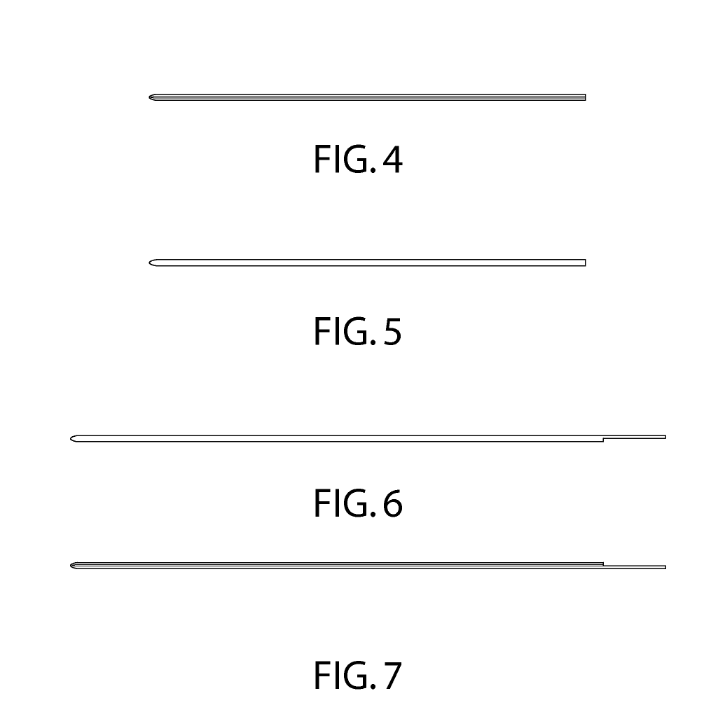

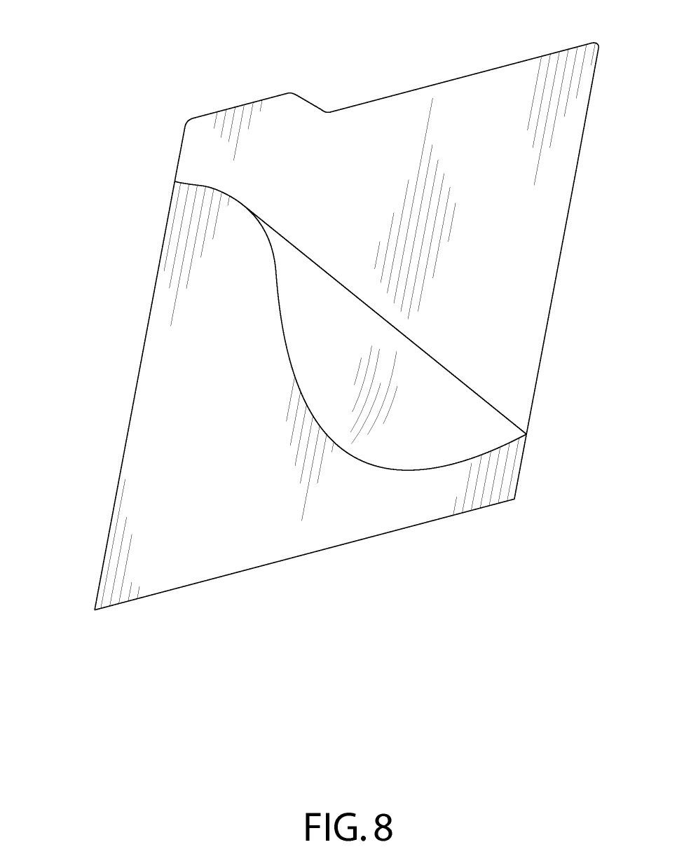

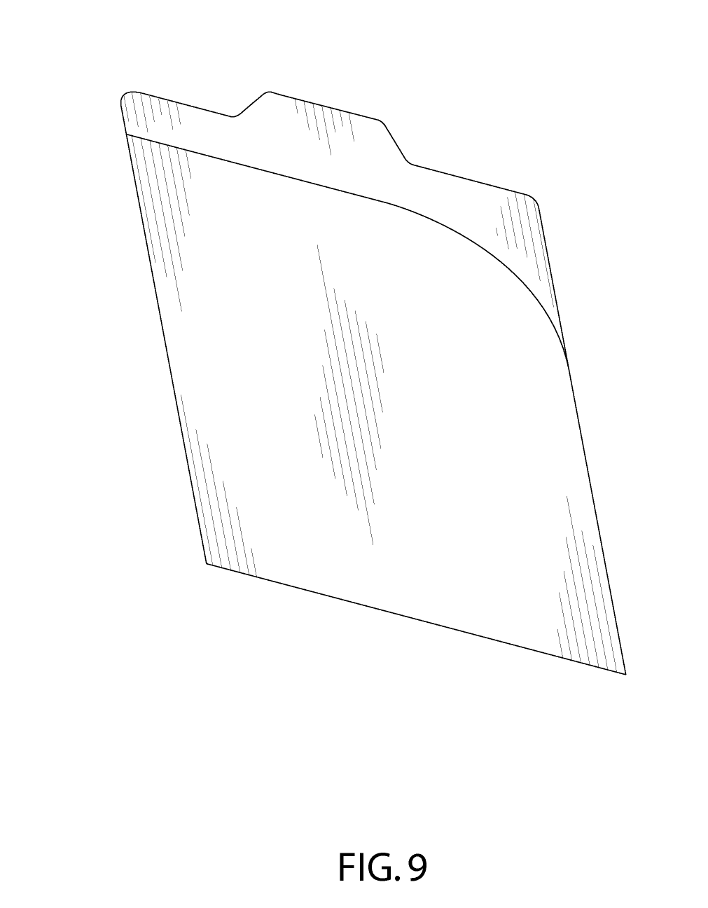

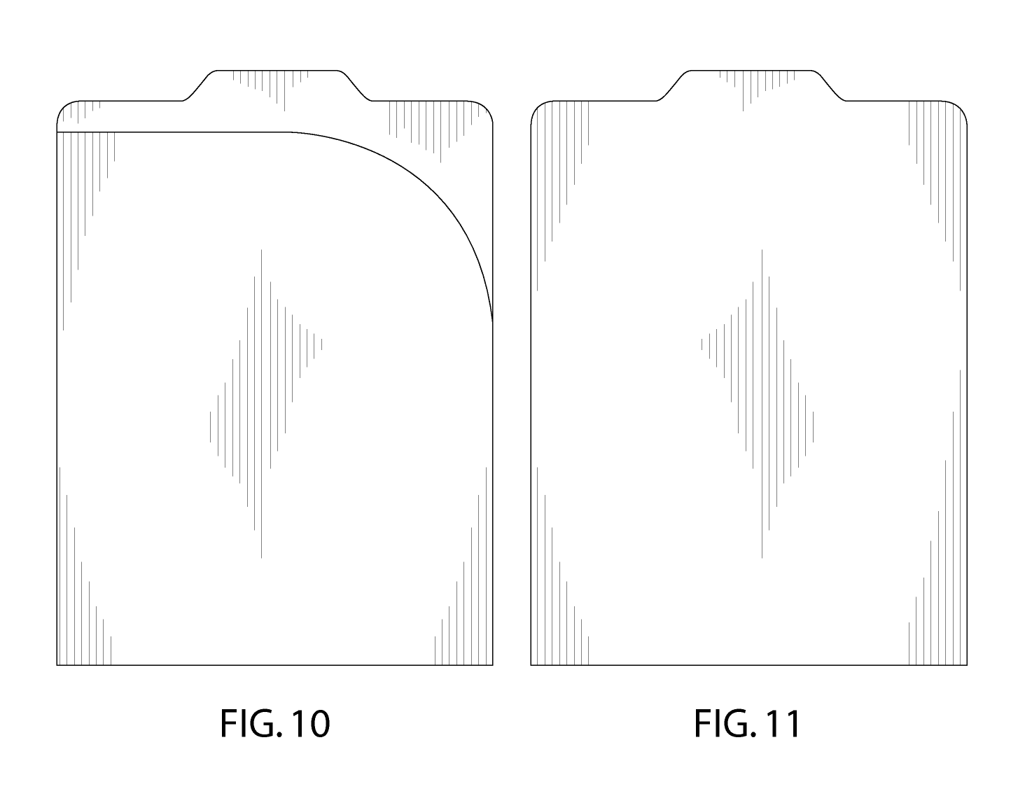

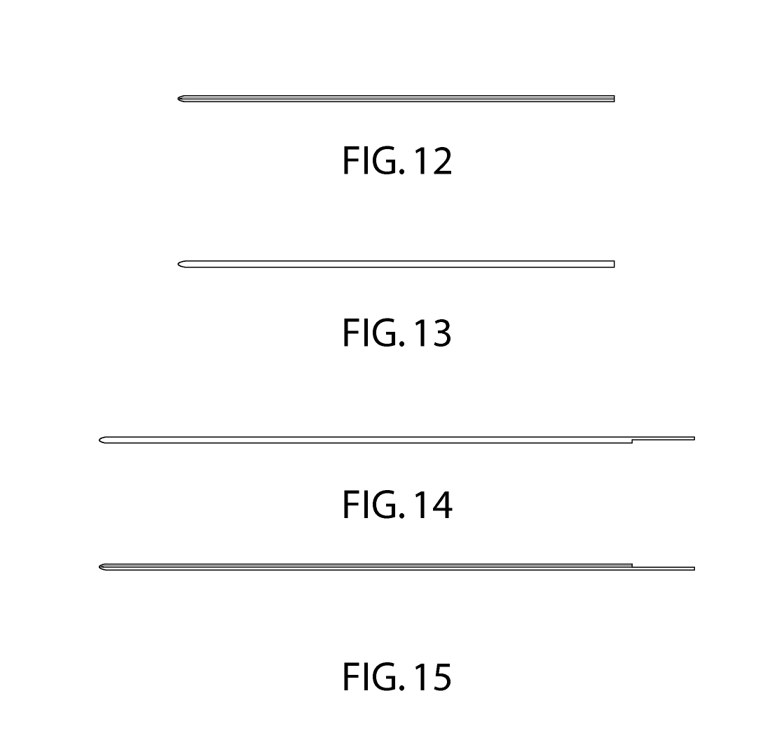

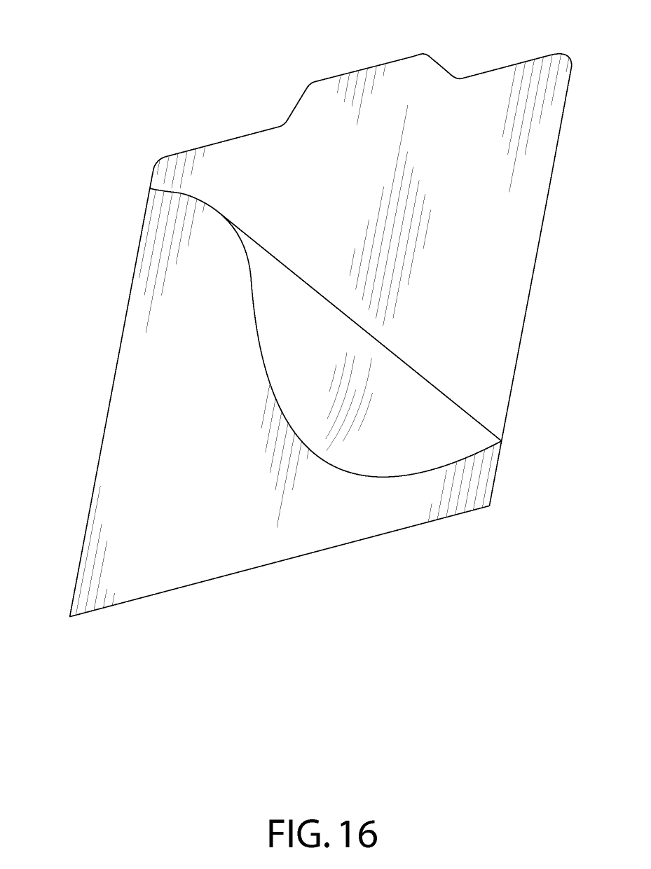

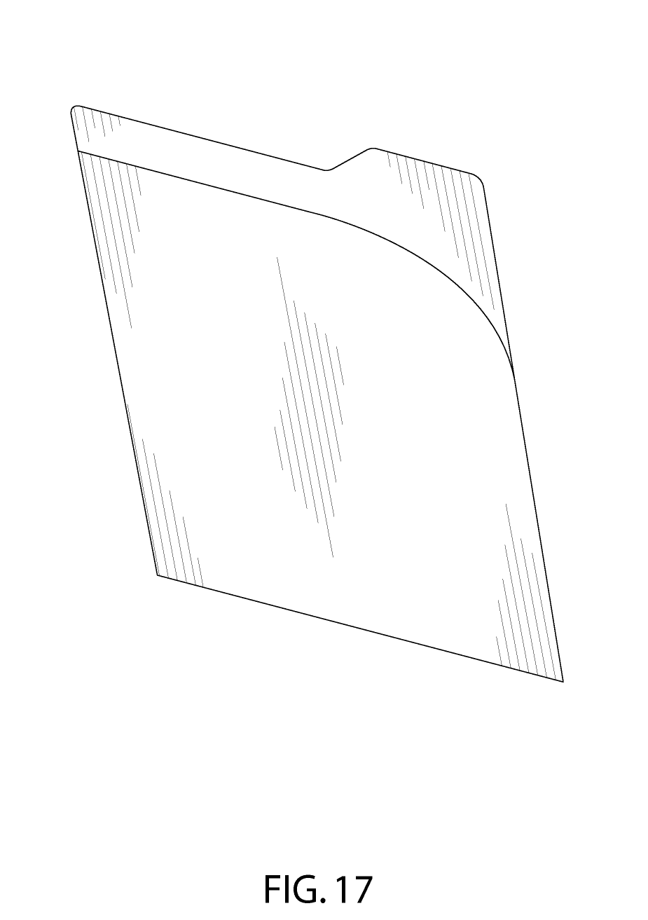

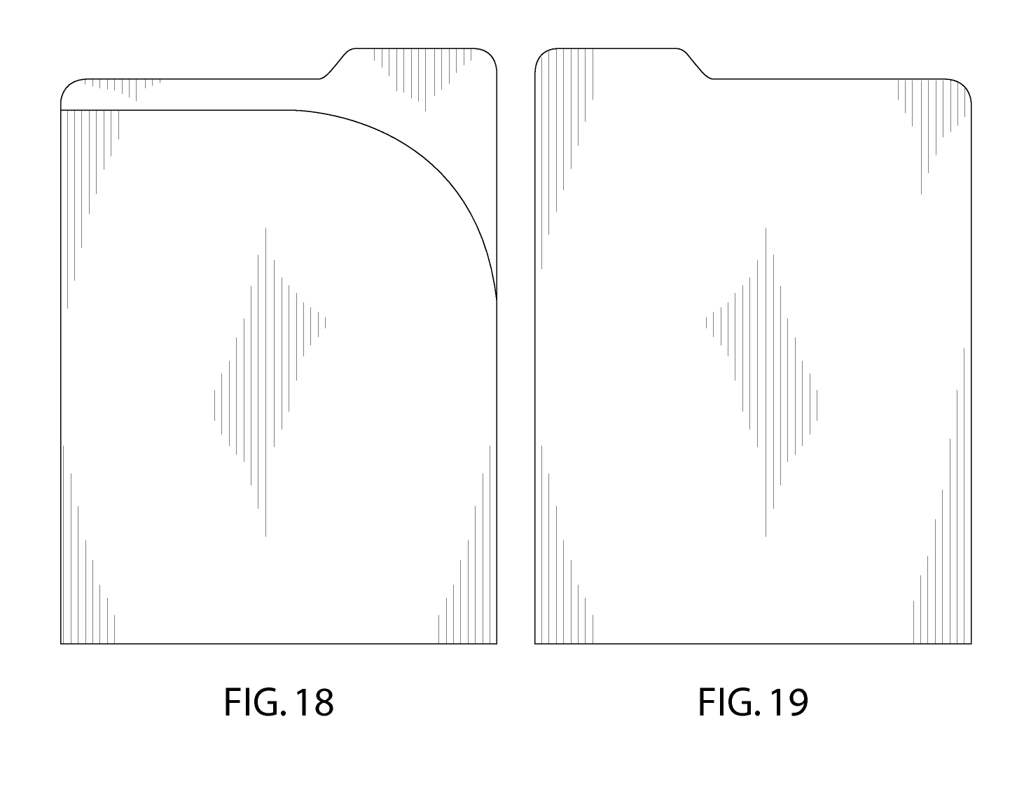

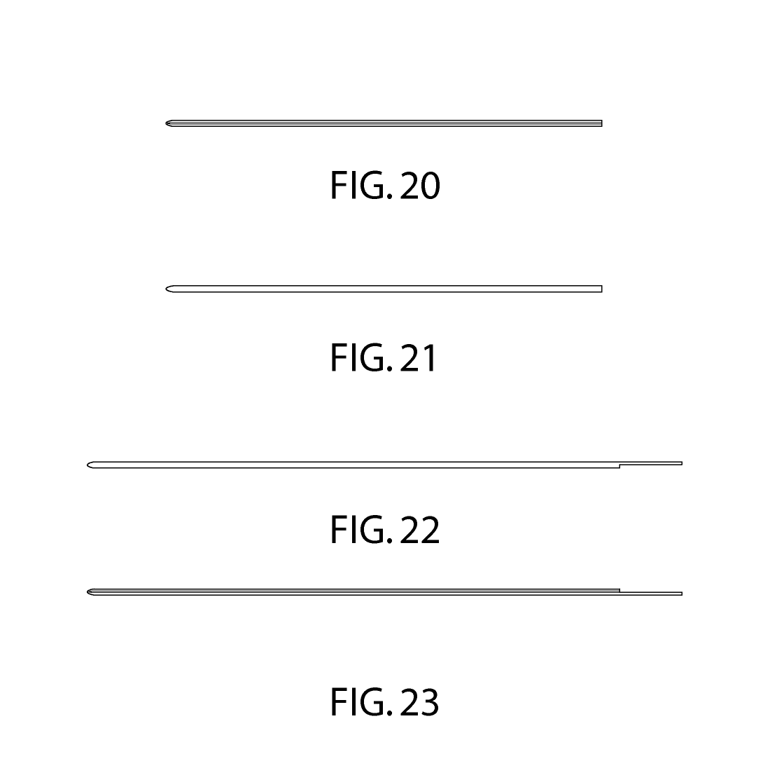

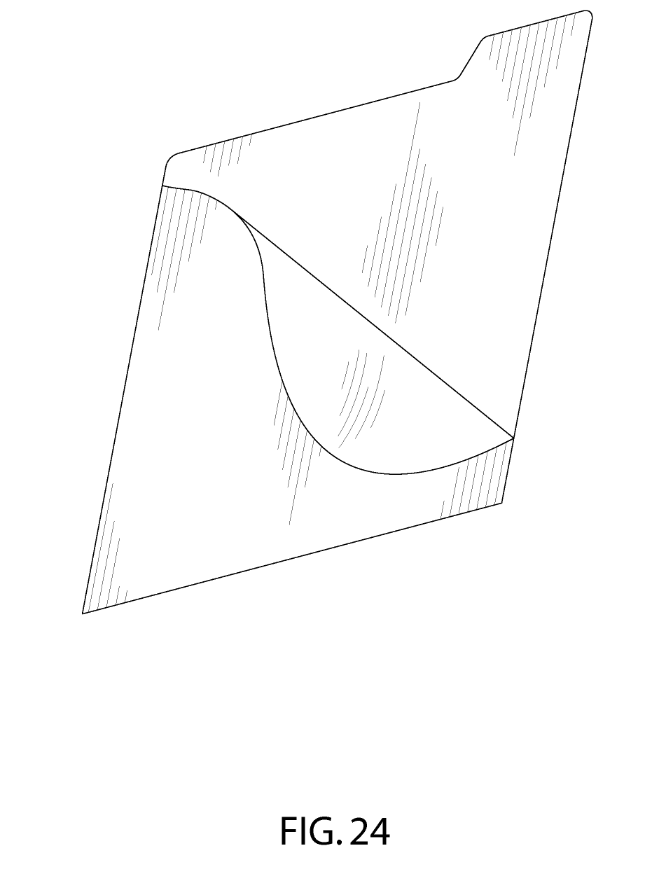

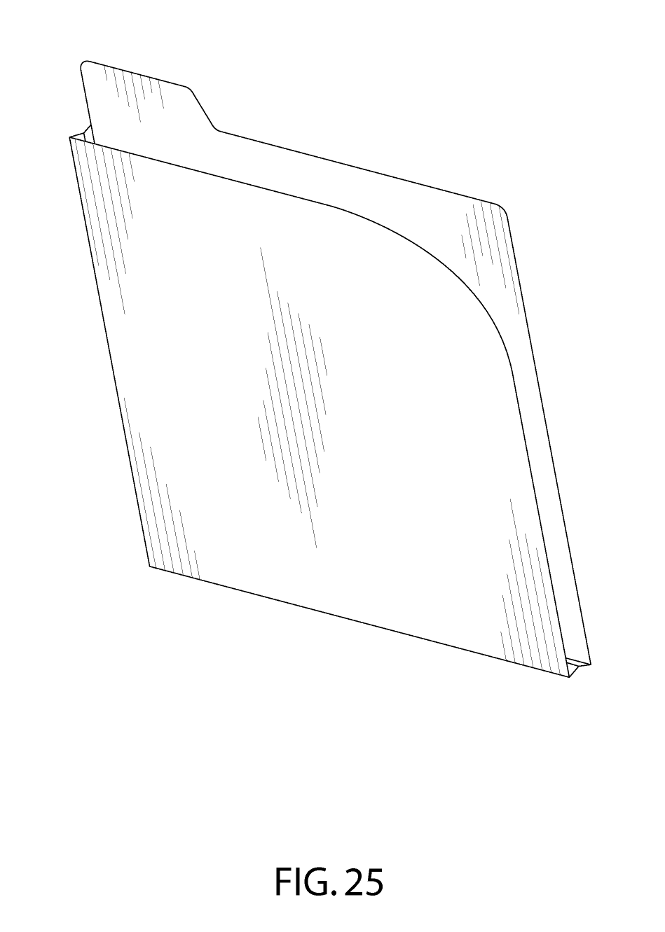

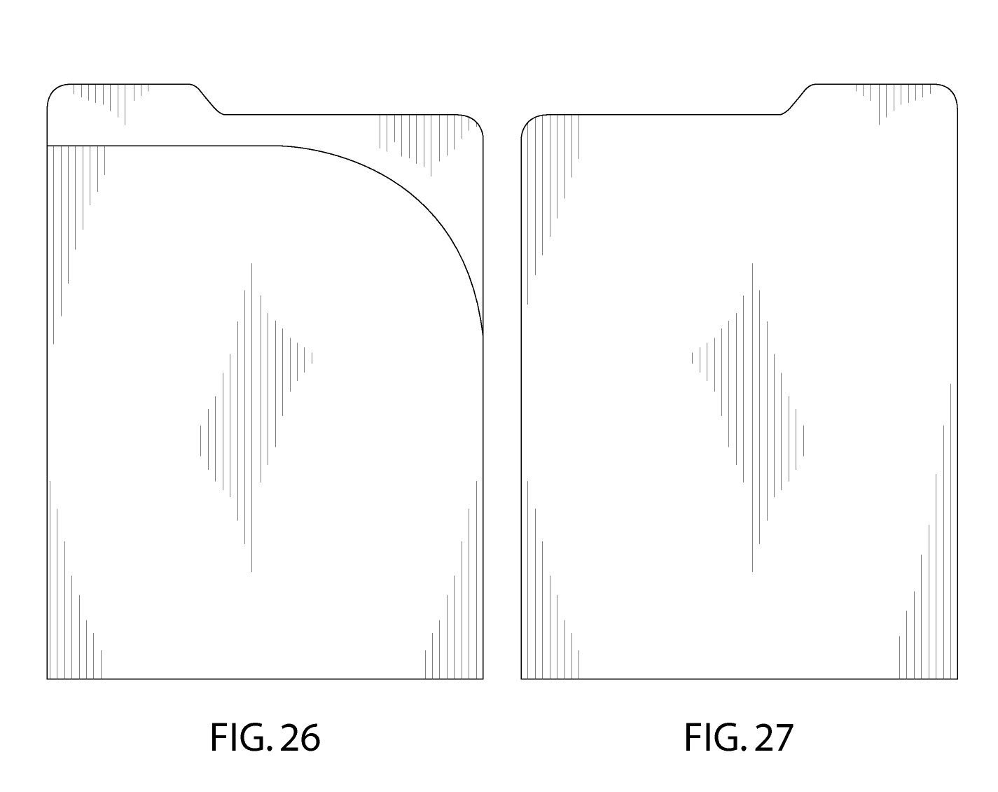

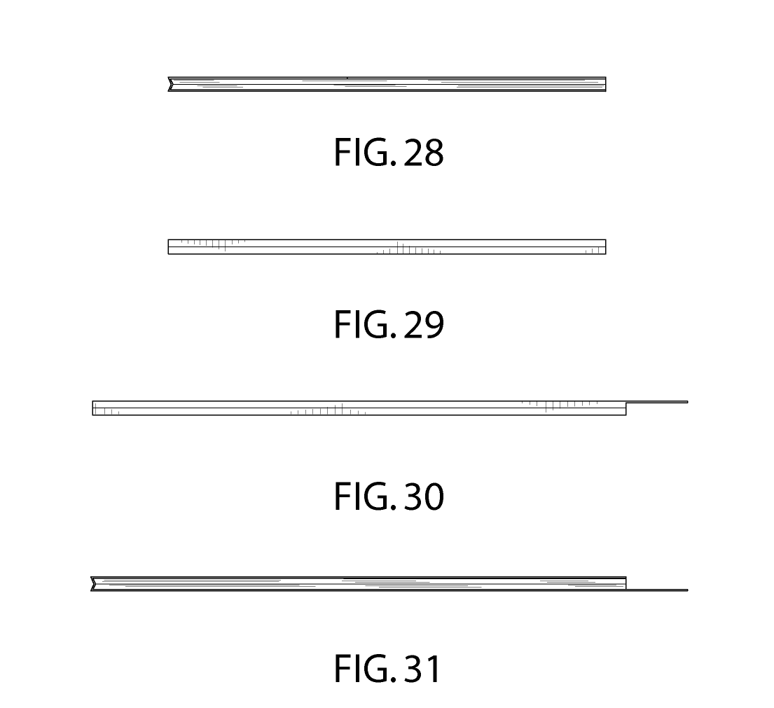

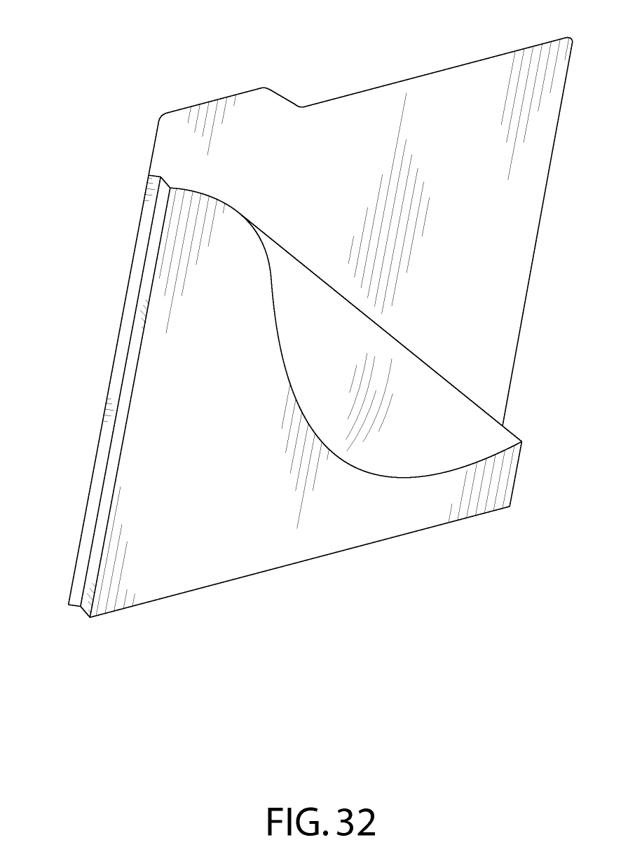

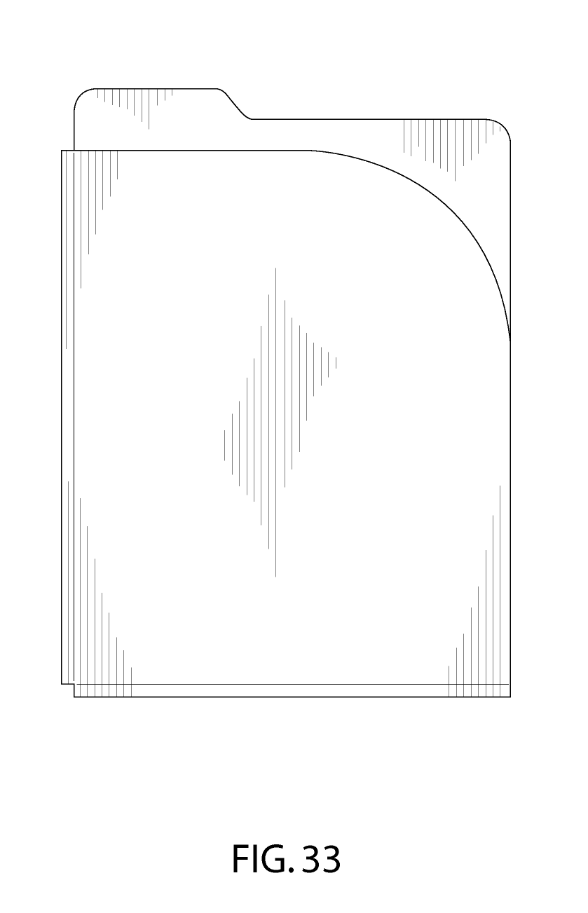

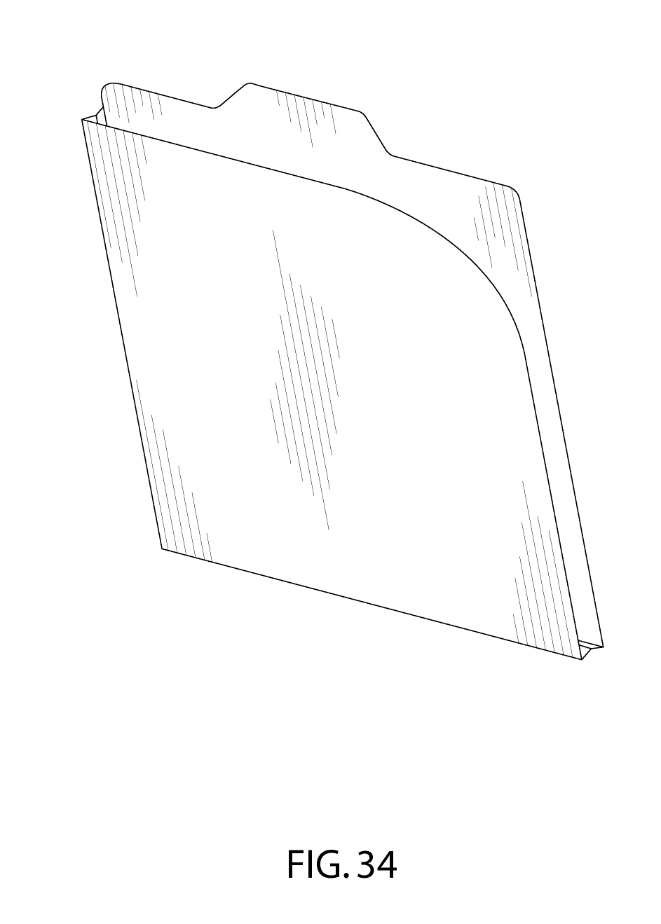

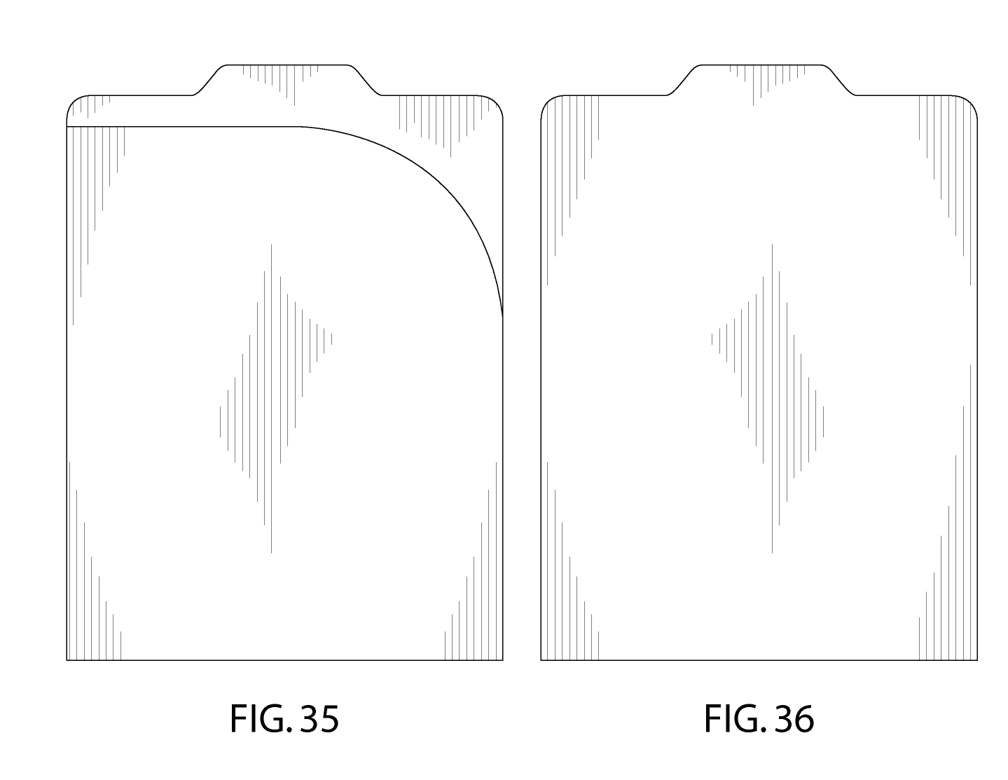

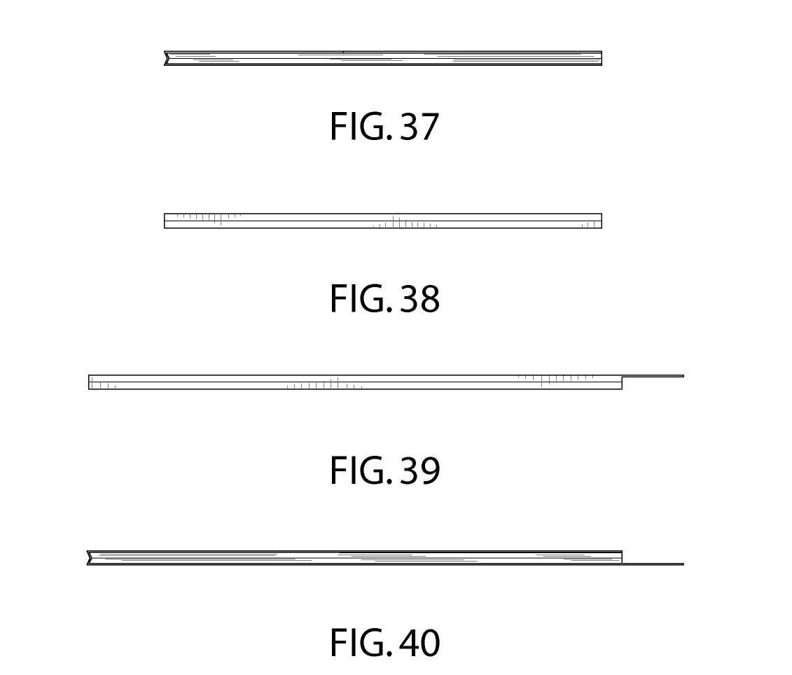

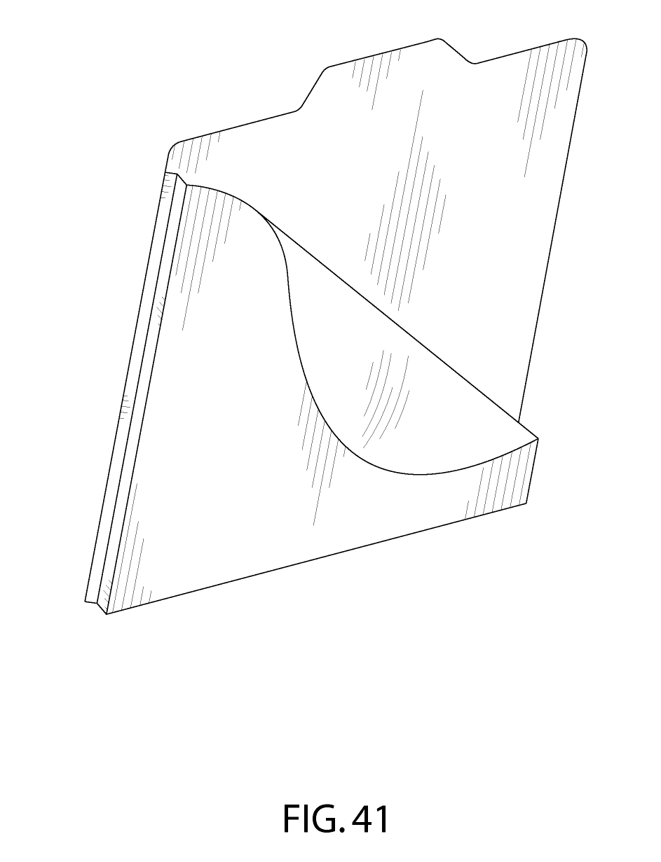

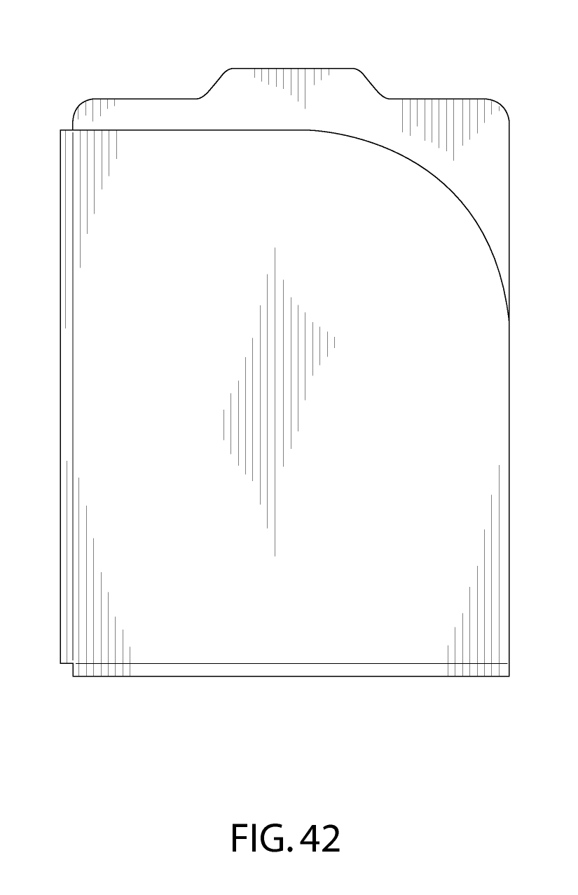

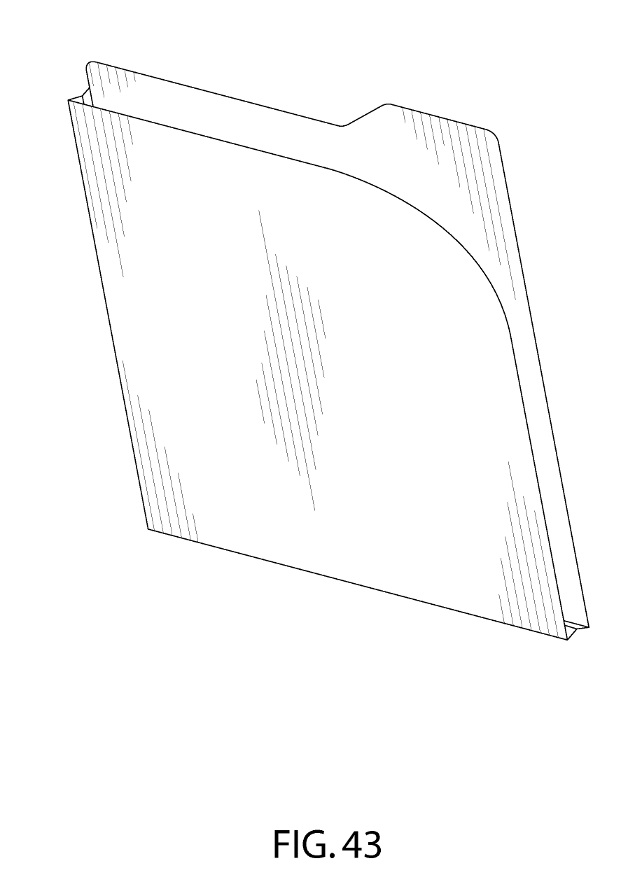

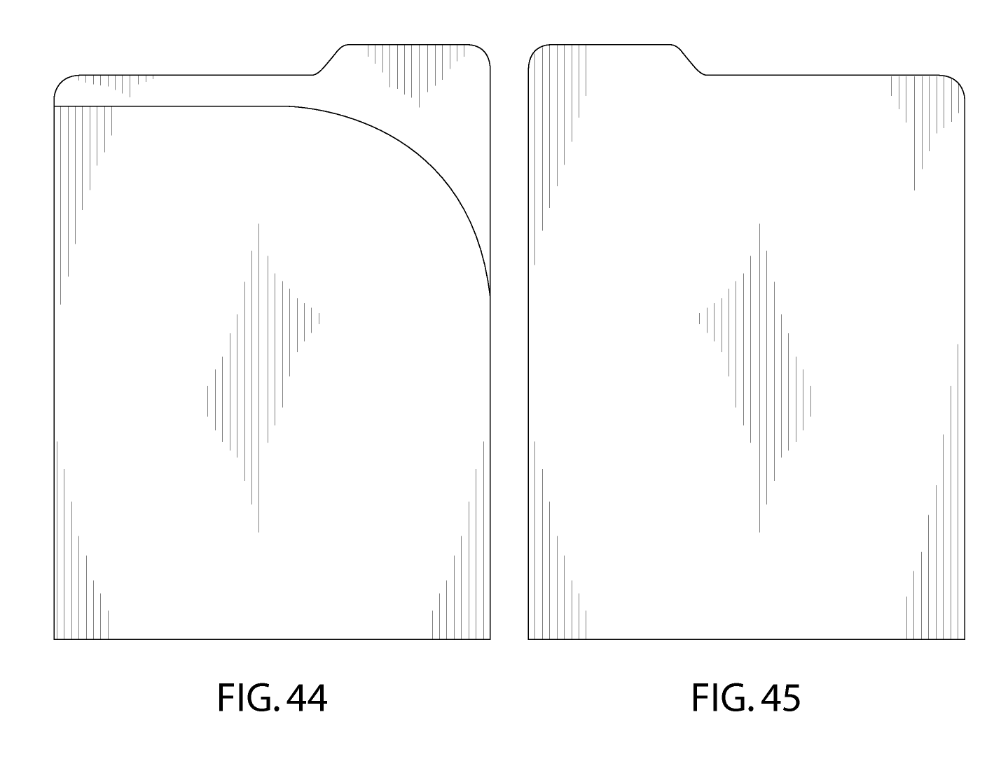

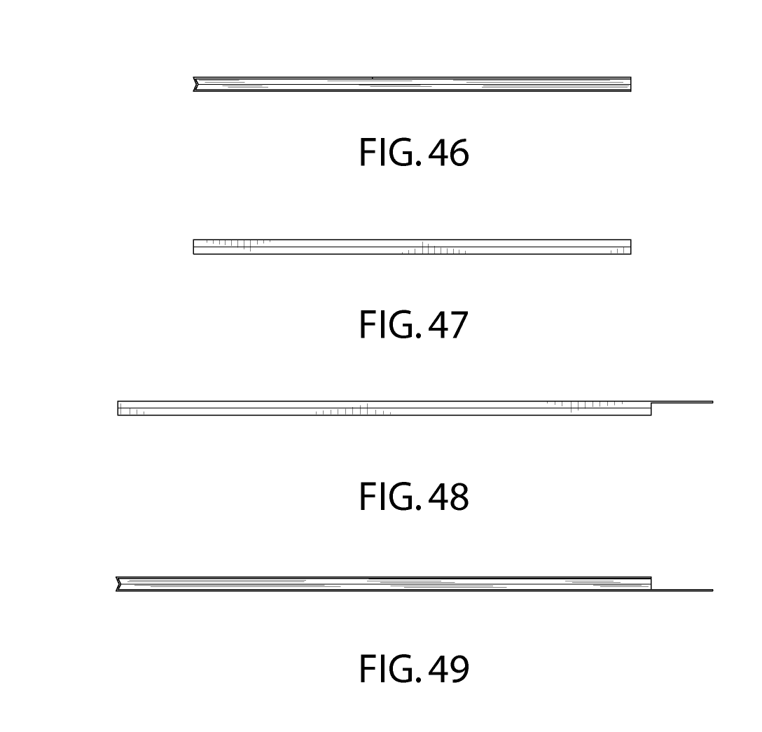

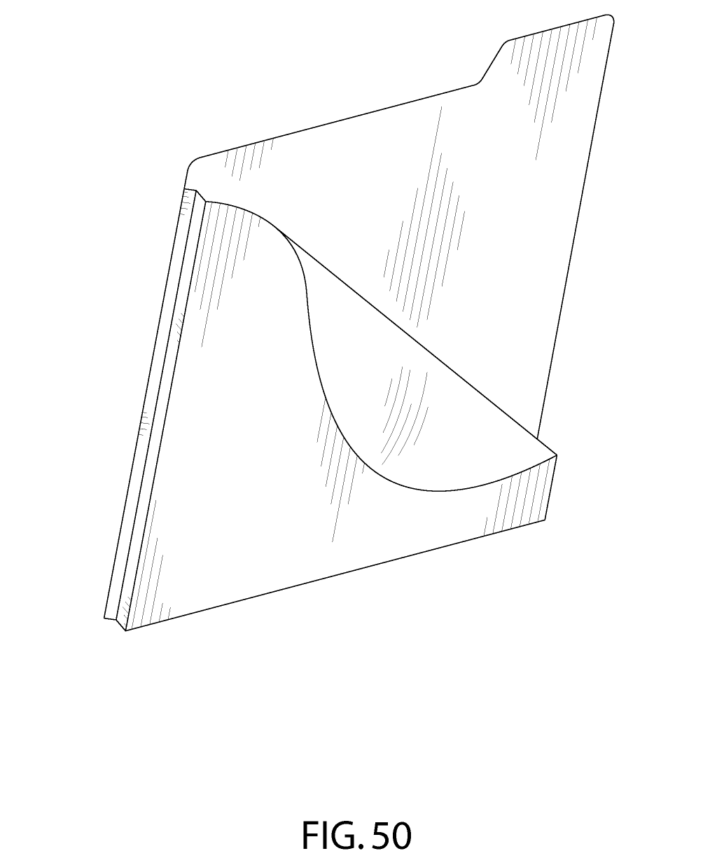

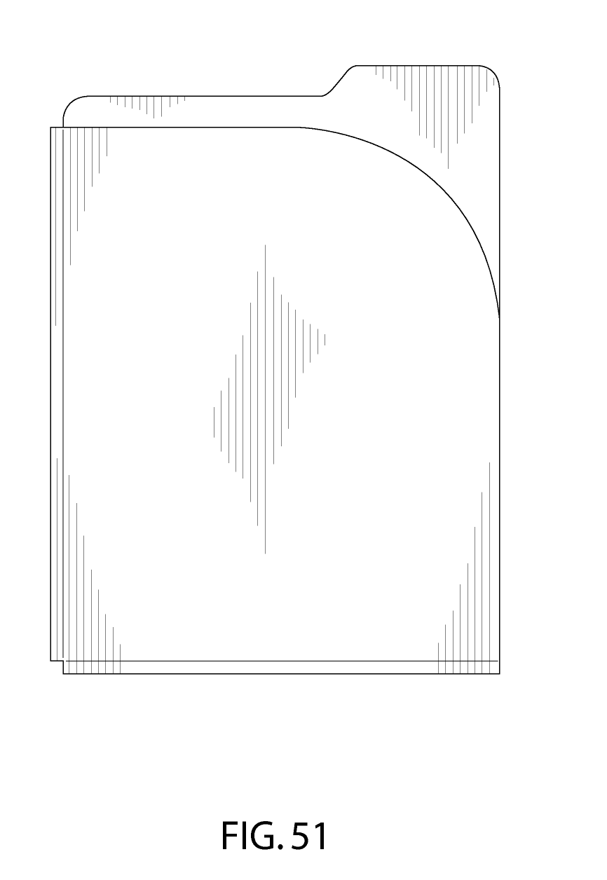

A twelfth embodiment of the folder (left tab; gusset; attached right and bottom) is attached at the bottom and right edges and has front and rear elevational views that are mirror images (vertical mirror line) of FIGS. 44 and 45, respectively; top and bottom plan views are mirror images (vertical mirror line) of FIGS. 46 and 47, respectively; and left and right side elevational views are mirror images (horizontal mirror line) of FIGS. 49 and 48, respectively.

The material thicknesses in the top, bottom, left side, and right side views have been exaggerated.

1. A folder comprising a front panel and a rear panel connected along at least a portion of respective bottom edges and at least a portion of at least one respective side edge while being open at their top edges,
wherein the front panel has an upper portion that is about ten and three-quarters inches or shorter above the bottom edge to permit the top of 8.5×11″ paper inside the folder to be exposed;
wherein the front panel has a width that is larger than eight and a half inches to cover the side edge of 8.5×11″ paper inside the folder;
wherein the rear panel has an un-tabbed upper portion that is about eleven and one-quarter inches or taller above the bottom edge to cover from behind the top of 8.5×11″ paper inside the folder; and
wherein the rear panel includes a tab extending at least a half inch above the un-tabbed upper portion of the rear panel, the tab being one of a left tab, a center tab, and a right tab, the left tab leaving space for a center tab and right tab of other folders, the center tab leaving space for a left tab and right tab of other folders, the right tab leaving space for a left tab and a center tab of other folders.

2. A folder comprising a front panel and a rear panel connected along at least a portion of respective bottom edges and at least a portion of at least one respective side edge while being open at their top edges,
wherein the front panel has an upper portion that is about ten and three-quarters inches or shorter above the bottom edge to permit the top of 8.5×11″ paper inside the folder to be exposed;
wherein the front panel has a width that is larger than eight and a half inches to cover the side edge of 8.5×11″ paper inside the folder;
wherein the rear panel has an un-tabbed upper portion that is about eleven and one-quarter inches or taller above the bottom edge to cover from behind the top of 8.5×11″ paper inside the folder; and
wherein the rear panel includes a tab extending at least a half inch above the un-tabbed upper portion of the rear panel, the tab being one of a left tab and a right tab, the left tab leaving space for a right tab of another folder, the right tab leaving space for a left tab of another folder.
